(19) United States
(12) Patent Application Publication
(10) Pub. No.: US 2019/0291918 A1
(43) Pub. Date: Sep. 26, 2019

(54) Pro joe-"the projector for the average joe"

(71) Applicant: Jacob Ariel Finch, Malta, NY (US)

(72) Inventor: Jacob Ariel Finch, Malta, NY (US)

(21) Appl. No.: 15/932,621

(22) Filed: Mar. 26, 2018

(51) Int. Cl. B65D 5/52; G02B 7/02

(52) U.S. Cl. CPC B65D 5/528; G02B 7/023

(57) ABSTRACT

The ProJoe is a great improvement and a new method of cell phone projection. It is a two-part cardboard stand-alone (a lens holder and a cell phone holder or stand) or “add-on” to an existing VR viewer that allows smartphones to project still images or video onto a blank wall or screen. This improvement allows for the user to inexpensively transform their cell phone into a real projector.

### CROSS REFERENCE TO RELATED APPLICATIONS

The present application claims priority from Provisional Application No. 62/601,806 filed on Mar. 30, 2017.

### BACKGROUND OF THE INVENTION

### Field of the Invention

The invention relates generally to providing a common cell phone with projection capabilities when utilized with this new device. This projection device is called a “ProJoe” or as the inventor calls it, “a projector for the average Joe.” It is a two-part “stand-alone” projection device or an “add-on” projection device to a Google Cardboard VR (virtual reality) viewer. More specifically, this novel invention creates an inexpensive and accessible projector, which allows the users the ability to be able to show a video or still photos that are projected from the cell phone camera (such as the iPhone or other smartphone) onto a white wall or small screen. A Google Cardboard VR viewer is also not required to operate the ProJoe. It is a simple and versatile invention with dual purposes.

The cell phone when placed on top of the stand rests against a small detachable (can be made of a hard plastic material or stiff cardboard) ledge that is on the stand. The stand when attached to the top of the VR viewer uses a small piece of a Velcro strip. A detachable plastic biconvex lens (encased in a hard plastic material or stiff cardboard) is placed on the front edge of the VR viewer also with the aid of Velcro. The cell phone can then “project” the image through the lens and the image can be seen on a wall. No electricity is required for the use of the ProJoe.

### PRIOR ART

It is known in the prior art that projectors, even basic ones, require a power supply, housing and circuit devices in order for the user to see images from a cell phone video or still photos projected onto a wall. This type of projection technology requires a higher level of skill to use than the ProJoe does to operate. The ease of use of the ProJoe is remarkable. All you do is adjust focal length by moving the lens further away from the cell phone. There are DIY projectors made with shoeboxes and the like but they lack innovative and creative design and some require reading skills to assemble. The ProJoe will be produced through the (probable) use of 3D printed technology and will require little assembly and practically no reading skills. Imagine the ease of use when a physician shows images of bacteria from his or her phone, projected onto the hospital room wall during early morning rounds. Or imagine a child playing with a doll and pretending they are watching the early Mickey Mouse film, “Steamboat Willie.” A bedroom wall then becomes a home theatre. From basic research, no such simple device exists. It is so intuitive that a child can understand it quite quickly. Put the cell phone on a stand and adjust focal length with lens and that's it.

### SUMMARY OF THE INVENTION AND ADVANTAGES

The subject invention comprises a method and apparatus for projecting visual images in a low-cost and very effective manner. The inventor states that his “ProJoe” is an invention that any “Joe” can use. The quick detachable lens (contains Velcro) and cell phone stand (contains Velcro) make for easy storage and note that a child can operate the device. Another version of the ProJoe contains no Velcro and can stand upright and alone, by virtue of it not being attached to a VR viewer. The ProJoe has both business and consumer applications. It can function as a small home theater device that anyone can operate easily and efficiently. A child can easily understand this device, as it is an intuitive projection system.

### BRIEF DESCRIPTION OF THE DRAWINGS

Various embodiments of the invention are disclosed in the following detailed description and accompanying drawings.

FIG. 1 schematically illustrates an angled front view of the cardboard VR viewer/ProJoe projector. #1 is the actual VR viewer, #2 is the biconvex plastic (acrylic) lens, #3 is the detachable cardboard holder “add-on” for the biconvex plastic lens, #4 is the cardboard material of the VR viewer, #5 is Velcro under the lens holding it in place, #6 is Velcro under the detachable cell phone holder or stand, #7 is the detachable cell phone “add-on.”

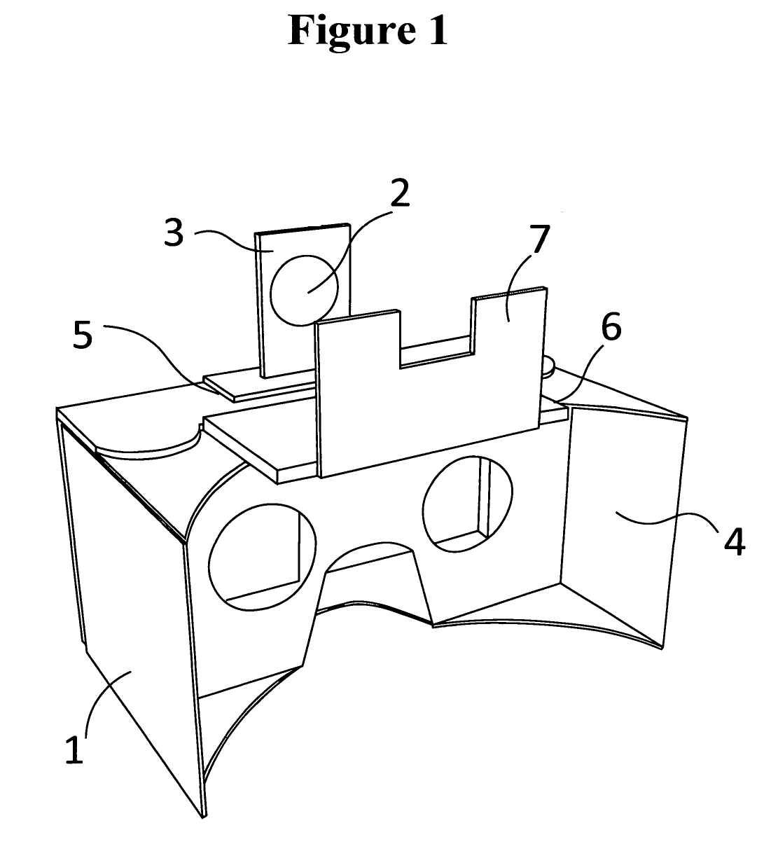

FIG. 2 illustrates a different perspective front view of the VR viewer/ProJoe projector.

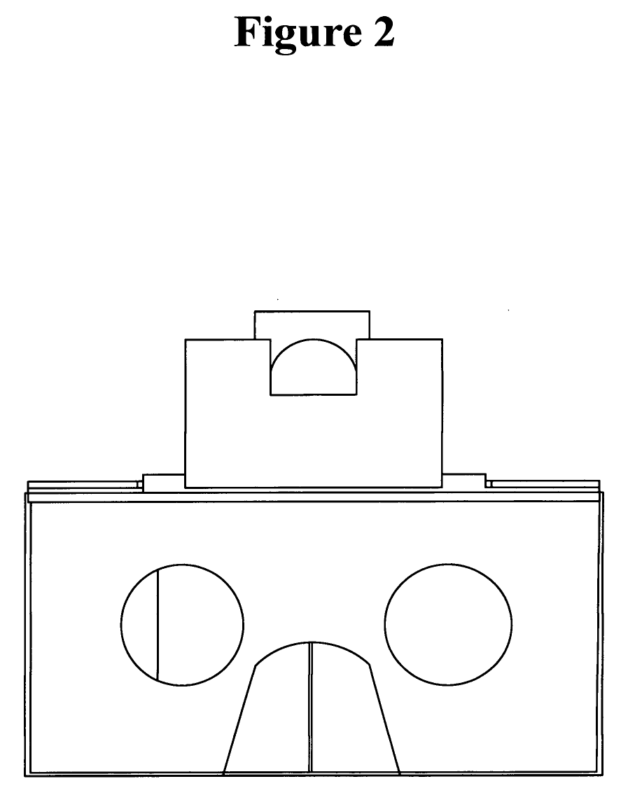

FIG. 3 illustrates a back view of the VR viewer/ProJoe projector.

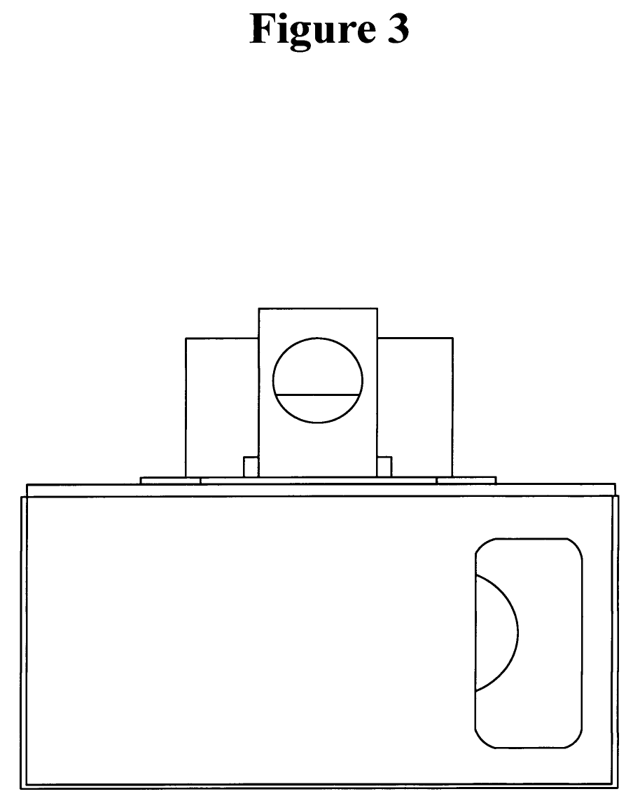

FIG. 4 illustrates a side view of the VR viewer/ProJoe projector.

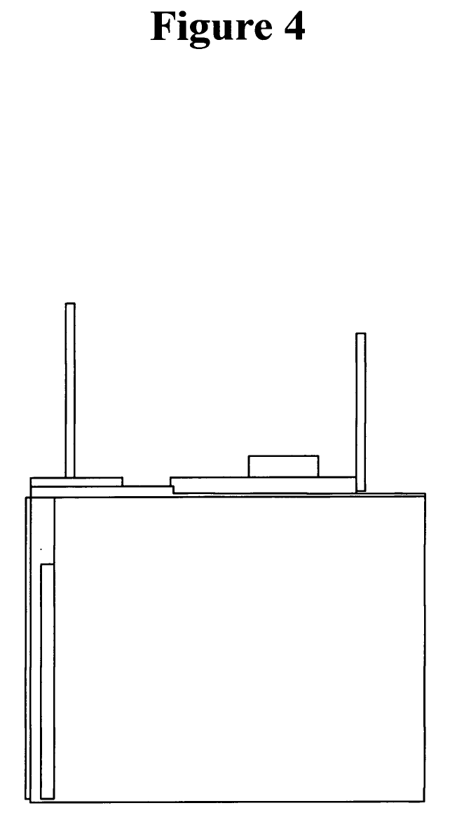

FIG. 5 illustrates an overhead view of the VR viewer/ProJoe projector.

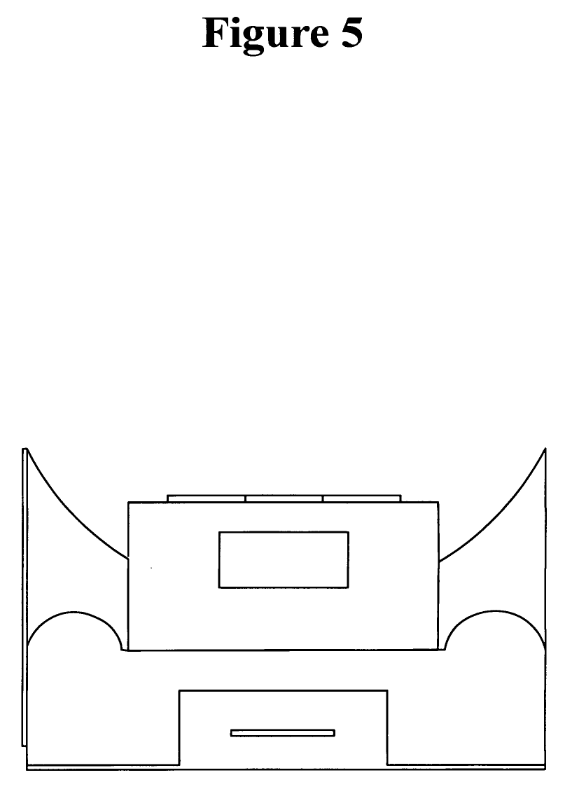

FIG. 6 illustrates the ProJoe's two detachable “add-ons.”

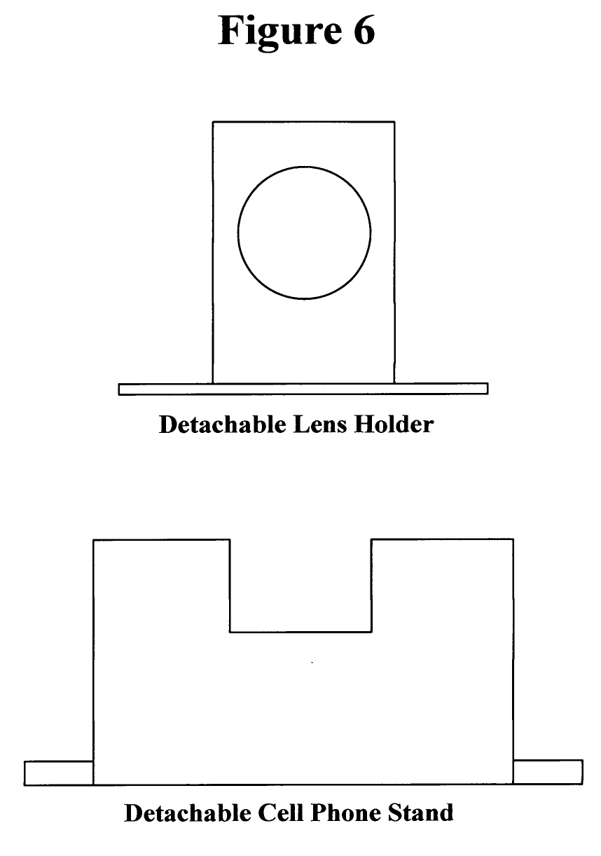

FIG. 7 illustrates a cell phone projecting an image through the lens “add-on.” It also illustrates #8 which is the small ledge that the cell phone is propped up by.

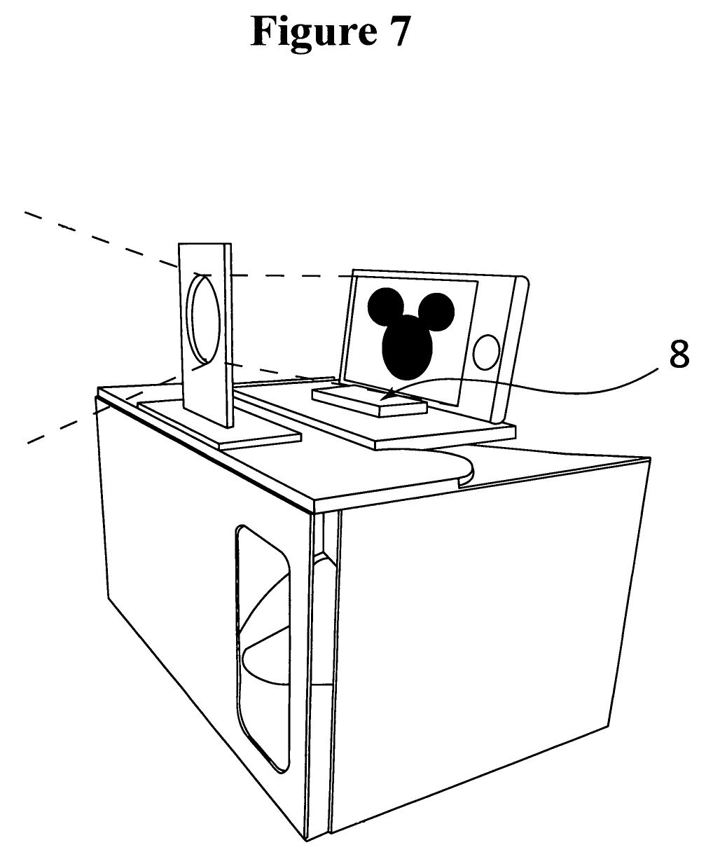

FIG. 8 illustrates another view of the ProJoe projecting an image.

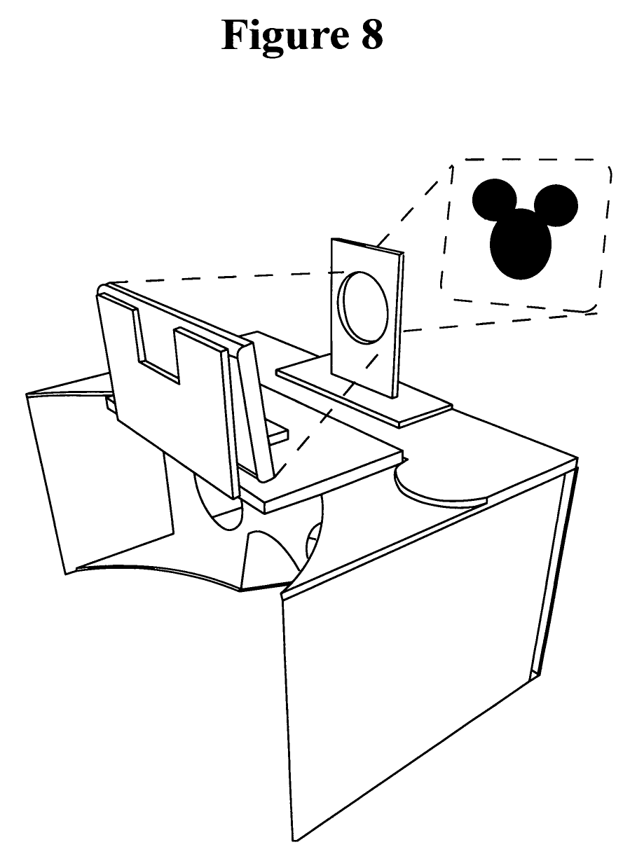

FIG. 9 illustrates a Google Cardboard VR viewer without the ProJoe device. (or add-ons.)

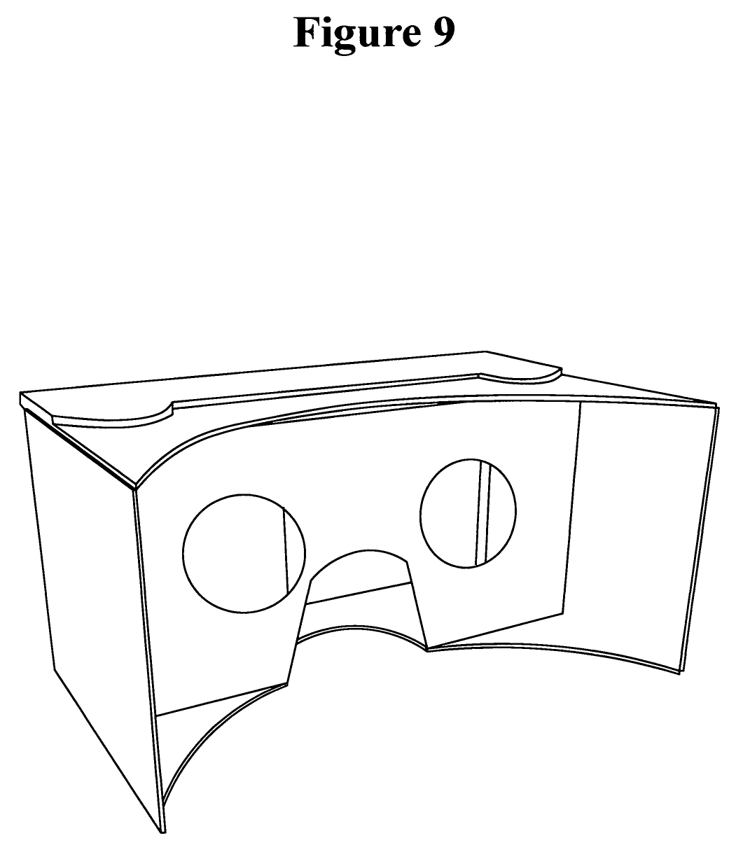

FIG. 10 illustrates the ProJoe device projecting an image.

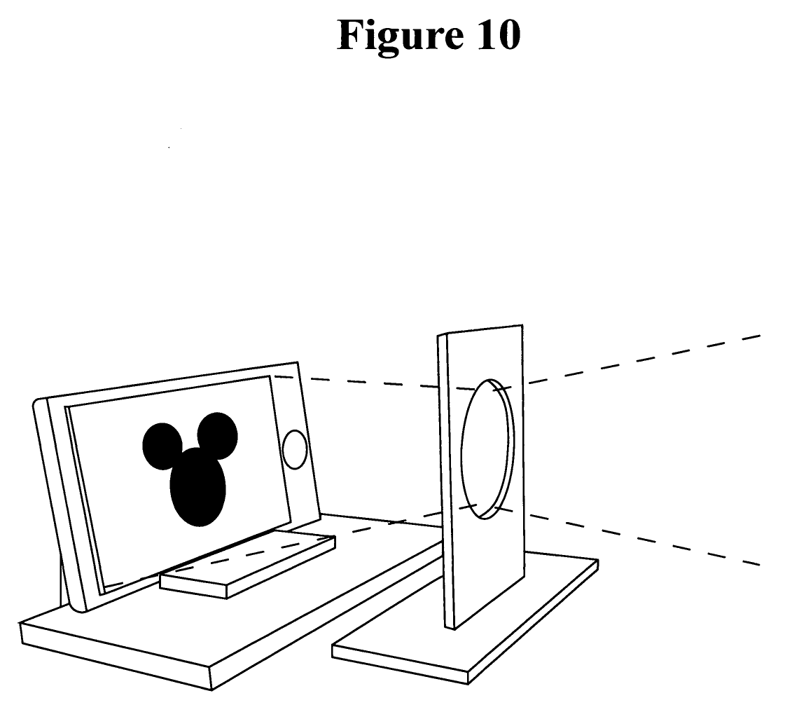

FIG. 11 illustrates another view of the ProJoe device projecting an image.

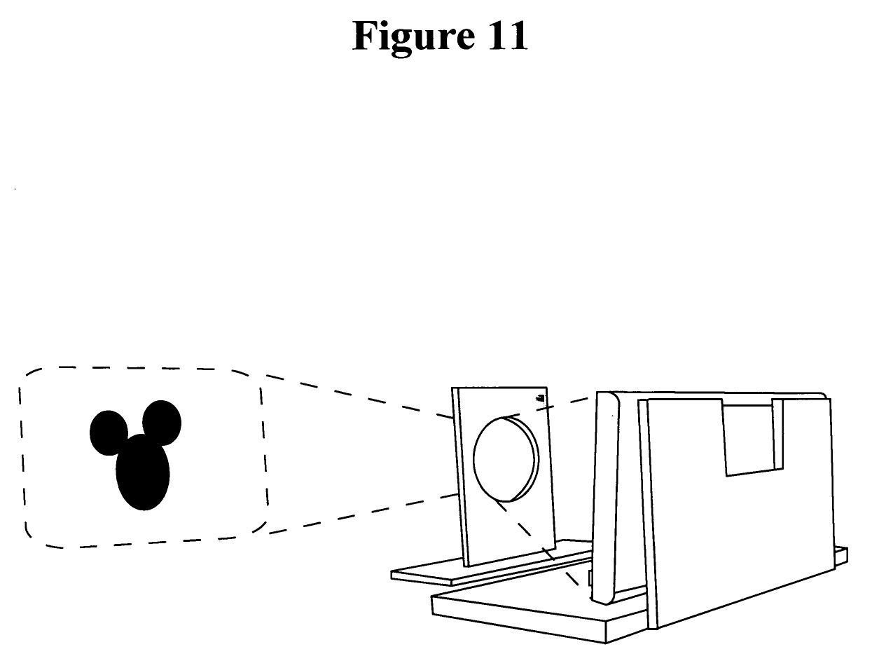

FIG. 12 is an illustration of the projection system.

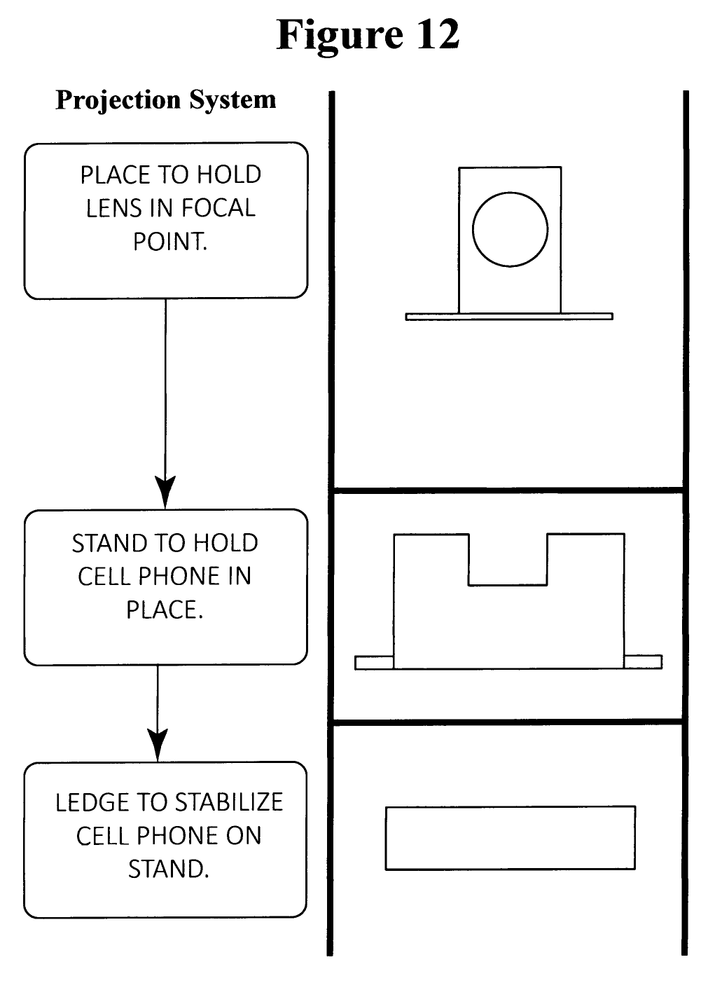

What is claimed is:

1. The “ProJoe” is a simple, light, well-designed and inexpensive cell phone projection modification, its two-piece “stand-alone” projection device can also be used as an “add-on” device to a Google Cardboard VR viewer, for use with a smartphone which projects images onto a blank wall, which is shown and described herein.
